(19) United States
(12) Patent Application Publication
(10) Pub. No.: US 2008/0223512 A1
(43) Pub. Date: Sep. 18, 2008

(54) Method and system for printing variable length adhesive labels

(75) Inventor: Mark E. Sievel, Newtown, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/724,561

(22) Filed: Mar. 15, 2007

(51) Int. Cl. B32B 38/04

(52) U.S. Cl. 156/250; 428/409

(57) ABSTRACT

Systems and methods for printing various length adhesive labels using continuous adhesive label stock and a mechanical cutter that eliminates problems associated with the build up of adhesive on the cutter blade are provided. A continuous label stock includes regions where adhesive is provided interspersed with regions where there is no adhesive provided. After printing has occurred, the continuous label stock is fed to a mechanical cutter that separates the printed label from the continuous label stock by cutting through a region where there is no adhesive provided. As such, no adhesive will be transferred to the cutter blade, thereby removing any possibility of a build up of adhesive on the cutter blade. Since there will not be any build up of adhesive on the cutter blade, problems associated with the build up of adhesive on the cutter blade are eliminated.

### FIELD OF THE INVENTION

The invention disclosed herein relates generally to printing systems, and more particularly to systems and methods for printing variable length adhesive labels.

### BACKGROUND OF THE INVENTION

The use of automated self-service systems for processing mail items, e.g., letters, packages, parcels, and the like, continues to increase as technology makes such systems easier to use and more secure. In such systems, a user can typically weigh a mail item, select from one or more different service levels for delivery of the mail item, and print one or more adhesive labels that are applied to the mail item. Such adhesive labels can include, for example, an indicium that evidences payment for the fee associated with delivery of the item by a postal service or private carrier, destination address and/or return address labels, and labels associated with special services selected by the sender for delivery of the mail item, e.g., delivery confirmation, insurance, etc.

Because of the various types of labels that can be printed by the self-service systems, there are several different sizes of labels. For example, a label that includes only an indicium can measure 4″ by 1.5″, a label including an indicium and special services designation can measure 4″ by 2.5″, and a label including a destination address can measure 4″ by 6″. To provide such different size labels, several approaches are known, including the use of separate printers each adapted to print a different sized pre-cut label, or mechanisms to feed the appropriately sized pre-cut label into a single printer based on the label that will be printed. The former approach, however, can significantly increase the cost of the self-service system, as multiple printers are required to print all of the adhesive labels that system needs to print. The latter approach, while reducing the need for multiple printers, will also increase the cost of the system. The use of multiple feed paths for different sizes of pre-cut label stocks increases the complexity of the system as well as the risk of mechanical failure, thereby increasing the service costs over the life of the self-service system. Another approach to providing different size adhesive labels is to provide a continuous supply of adhesive label stock in the printer. A mechanical cutter is located at the output of the printer to cut the adhesive label stock at the desired length after printing. Such mechanical cutters utilize a sharpened edge that is passed through the label stock to cut the desired length label. One example of a mechanical cutter is similar to a guillotine, in which the label stock is passed through a slit in a frame that holds a cutting blade. The cutting blade is then moved in the frame transversely to the direction of movement of the label stock such that is passes through the slit, thereby cutting the label stock. After cutting has occurred, the separated label stock is transported to an opening where it is output from the self-service system. The label stock remaining in the self-service system is transported in the reverse direction back into the printer, such that printing of the next label will occur near the leading edge of the label stock. Other types of mechanical cutters include rotary style cutters, in which the edge of a circular blade is rolled over the label stock to cut the label stock. Such mechanical cutters are well known, and perform well in many applications including, for example, receipt printers and the like.

There are problems, however, with the use of such mechanical cutters, especially when being used to cut adhesive label stock. Mechanical cutters are not suitable for cutting through label stock that is provided with a self-adhesive, as the adhesive transfers to the blade during the cutting operation. The build up of adhesive on the blade reduces the effectiveness of the blade for cutting, resulting in tearing or ripping of the label stock instead of a clean cut. The ripped or torn edges can cause the label stock to jam during transport of either the separated label or the remaining label stock back into the printer. Eventually, build up of adhesive on the blade will cause the blade itself to jam, preventing any labels from being separated from the label stock. Either situation results in unacceptable performance of the self-service system.

Thus, there exists a need for systems and methods for printing variable length adhesive labels using a continuous supply of adhesive label stock and a mechanical cutter.

### SUMMARY OF THE INVENTION

The present invention alleviates the problems associated with the prior art and provides systems and methods for printing various length adhesive labels using continuous adhesive label stock and a mechanical cutter that eliminates problems associated with the build up of adhesive on the cutter blade.

In accordance with embodiments of the present invention, a continuous supply of label stock is provided to a printer from, for example, either a roll or fanfold paper. The continuous label stock includes zones where adhesive is provided interspersed with zones where there is no adhesive provided. After printing has occurred, the continuous label stock is fed to a mechanical cutter that separates the printed label from the continuous label stock by cutting through a zone where there is no adhesive provided. By preferably alternating the different zones in which adhesive is and is not provided in a repeating pattern, it is possible to select any length label that is a multiple of the repeating pattern, while cutting through areas of the continuous label stock where there is no adhesive. As such, no adhesive will be transferred to the cutter blade, thereby removing any possibility of a build up of adhesive on the cutter blade. Since there will not be any build up of adhesive on the cutter blade, problems associated with the build up of adhesive on the cutter blade are eliminated.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate a presently preferred embodiment of the invention, and together with the general description given above and the detailed description given below, serve to explain the principles of the invention. As shown throughout the drawings, like reference numerals designate like or corresponding parts.

FIG. 1 illustrates in block diagram form a portion of a printing system in which the present invention can be utilized;

FIG. 2 illustrates an example of a continuous adhesive label stock according to an embodiment of the present invention;

FIG. 3 illustrates a side view of the continuous adhesive label stock illustrated in FIG. 2;

FIG. 4 illustrates an example of a continuous adhesive label stock according to another embodiment of the present invention; and

FIG. 5 illustrates in flow chart form an example of the operation of the printing system of FIG. 1 using continuous adhesive label stock according to the present invention.

### DETAILED DESCRIPTION OF THE PRESENT INVENTION

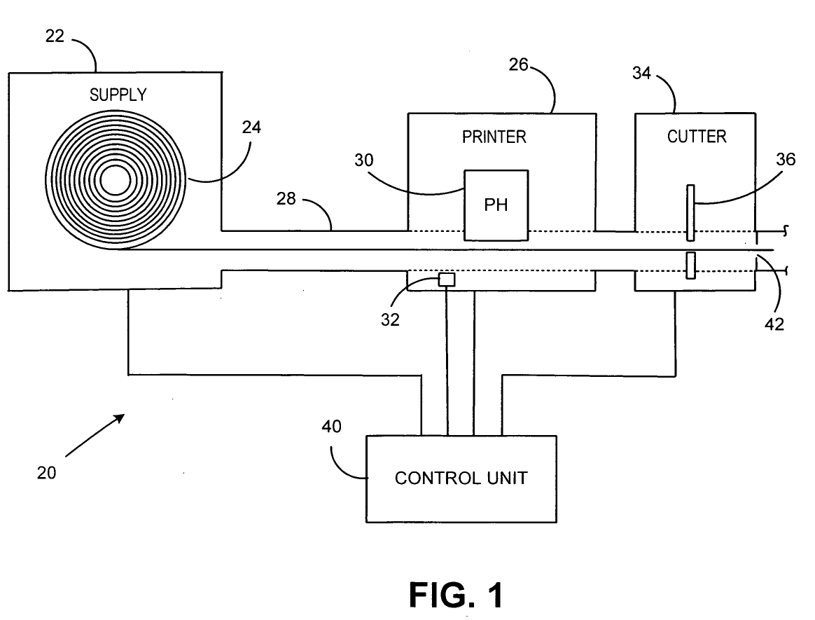

In describing the present invention, reference is made to the drawings, wherein there is seen in FIG. 1 a portion of a printing system 20 in which the present invention can be utilized. Printing system 20 can be utilized in any application where it is desired to print variable length self-adhesive labels using a cutter mechanism to separate the printed labels from a continuous label stock, including, for example, a self-service system for processing mail items. As used herein, a continuous label stock means a label stock where any portion can be used for printing a label. A continuous label stock does not include label stock having any pre-cut labels that can be removed from the label stock, or any perforations or scoring for the separation of one portion from another. Printing system 20 includes a label supply 22 which is adapted to feed a continuous label stock 24 to a printer 26 via a transport 28. Label stock 24 could be provided, for example, in the form of a roll, fanfold paper, or any other form capable of supplying label stock. Printer 26 can be, for example, a thermal printer, an ink jet printer, or any other type of printer suitable for printing images on the label stock 24. The transport 28 can be any conventional type of transport system including, for example, rollers or belts that are controlled by a stepper motor or the like, that are suitable to move the label stock 24 in either direction through the printing system 20. The printer 26 includes a print head 30 used to print graphic images on the label stock 24. Printer 26 may also include one or more sensors 32, which may be, for example, optical sensors, that are utilized to locate the leading edge of the label stock 24 and/or registration markings provided along the edge of the label stock 24 and/or glue lines along the label stock 24 that can provide indications of positioning and movement of the label stock 24. Other sensors may also be provided anywhere along the path of the transport 28. A cutter mechanism 34 for cutting the printed portion of the label stock 24 from the supply is located downstream of the printer 24. Cutter mechanism 34 can be any type of device that utilizes a sharpened edge 36, e.g., cutter blade, to cut the portion of label stock 24 that includes the printed image from the supply. A control unit 40, which may be, for example, a general or special purpose microprocessor or application specific integrated circuit, may be utilized to control the operation of the printing system 20.

When a supply of continuous label stock 24 is placed into the label supply 22, the transport 28 will transport the leading edge of the label stock 24 until it or a registration mark is sensed by the sensor 32. The transport 28 will then move the label stock 24 a predetermined distance, using, for example, a predetermined number of steps of a stepper motor, such that the leading edge of the label stock 24 is adjacent to the print head 30. The label stock 24 is then in position for printing. When a label is printed, the transport 28 transports the label stock 24 past the print head 30 and then into the cutter 34. The cutter 34, using the blade 36, cuts the label stock 24 to separate the portion having the printed image from the supply. The cut portion then passes through an opening 42 in the cutter 34 and can be applied to an article, e.g., a mail item or the like. The transport 28 is then reversed in direction to pull the new leading edge of the label stock 24 back from the cutter 34 and return it to a ready position for printing a subsequent label. Because the length of the labels being printed by the printing system 20 is variable, the control unit 40 coordinates the movement of the label stock 24 through the printer 26 and cutter 34, using, for example, the movement of the transport 28, in conjunction with sensor 32 and/or other sensors located along the path of transport 28 to detect the leading edge of the label stock 24 and the registration markings provided along the edge of the label stock 24. Such markings could include, for example, bars that are spaced along predetermined intervals. By coordinating movement of the label stock 24, the printable area of the label stock 24 is efficiently used and there is minimal waste of the label stock 24, i.e., there are no large areas of the label stock 24 that are not utilized for printing. Thus, the printing of an image on a portion of the label stock 24 starts very close to the leading edge of the label stock 24, and the label stock 24 is cut by the cutter 34 very close to the end of the printed image, thereby ensuring that as many labels as possible can be printed using the label stock 24.

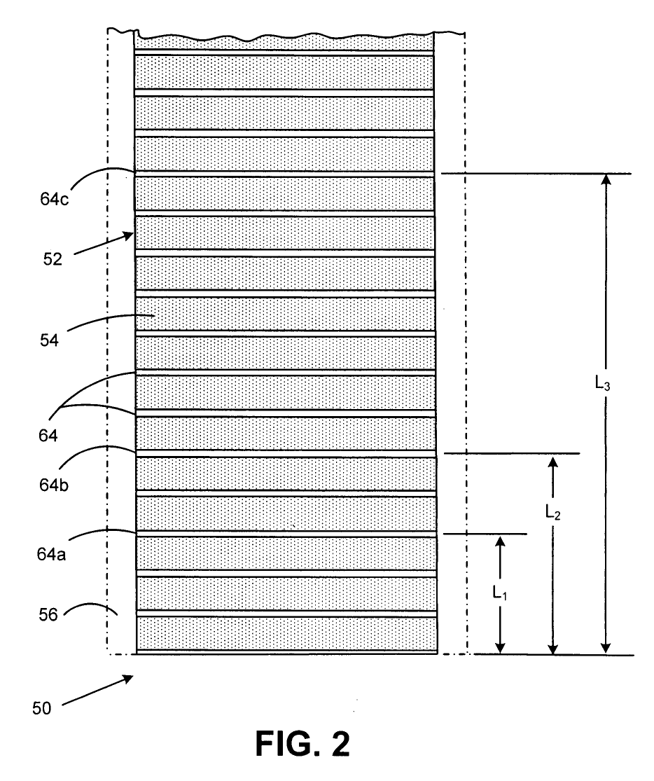

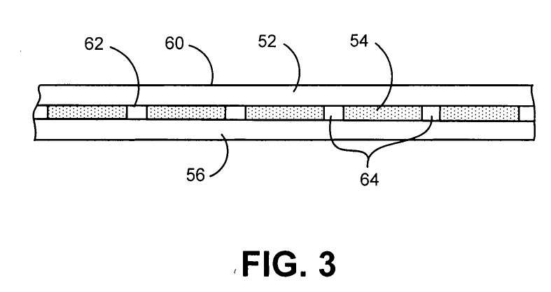

FIG. 2 illustrates an example of a portion 50 of the adhesive label stock 24 that, when used by the printing system 20, will prevent the build up of any adhesive on the cutter blade 36, thereby preventing any malfunctions of the printing system 20 due to such build up. FIG. 3 illustrates a side view of the adhesive label stock 24 illustrated in FIG. 2. As can be seen from FIGS. 2 and 3, adhesive label stock 24 preferably includes a release liner 56 and a label liner 52 held together by regions of pressure sensitive adhesive 54. Alternatively, label stock 245 can be a linerless label stock. Adhesive 54 can be, for example, an acrylic adhesive or any other type of adhesive suitable for label use. The label liner 52 is formed of a media suitable for the type of printing to be employed. For example, if the printer 26 is a thermal printer, the label liner 52 would be a thermal media suitable for thermal printing. The image will be printed on a top surface 60 of the label liner 52. The release liner 56 includes a silicone impregnated or wax-like surface that allows the release liner 56 to be removed from the adhesive 54 without damaging the adhesive 54, which remains adhered to the label liner 52. The label liner 52 with the adhesive 54 on the back 62 can then be applied to an article where it will adhere due to the adhesive 54. FIG. 2 shows a view of the label liner 52 and pressure sensitive adhesive 54 through the release liner 56 (shown in phantom). Preferably, the release liner 56 is wider than the label liner 52, and therefore includes a margin along each edge of the label stock 24 as shown in FIG. 2. As can be seen from FIGS. 2 and 3, the adhesive 54 is not applied along the entire length of the back 62 of the label liner 52, but instead is provided only in selected regions such that there are regions 64 where adhesive is not provided along the back 62 of the label liner 52. Preferably, the regions 64 alternate with the regions of adhesive 54 and are provided as repeating bands along the entire length of the label stock 24. The regions 64 extend across the full width of the label stock 24, thereby allowing a portion of the label stock 24 to be cut from the end of the label stock 24 without having to contact any of the regions of adhesive 54. Where the adhesive 54 is applied to the label liner 52, it preferably extends across the full width of the label liner 52, e.g., from side to side, as illustrated in FIG. 2. This ensures that the edges of the resulting label will sufficiently adhere to the surface upon which the label is applied. While the shape of the regions of adhesive 54 illustrated in FIG. 2 is rectangular, it should be understood that the regions of adhesive 54 need not be rectangular. As an example, the corners of each regions of adhesive 54 may be chamfered to aid in separating the label liner 52 and release liner 56.

The length of each region 64, as well as the length of each area of adhesive 54, can be based on the anticipated size of each of the labels that will be printed by the printing system 20. For example, for use in a self-service processing system for processing mail items, it is anticipated that the printing system 20 will print labels that are sized in one-half inch increments from the smallest to the largest. Such labels can include, for example, an indicium in which the label measures 4″ by 1.5″, a label including an indicium and special services designation that measures 4″ by 2.5″, and a label including a destination address that measures 4″ by 6″. In such a situation, each of the regions of adhesive 54 can be approximately ⅜″ long, and each of the regions 64 where no adhesive is provided can measure approximately ⅛″ long. Although FIG. 2 is not drawn to scale, it can be seen that if each of the regions of adhesive 54 were ⅜″ long, and each of the regions 64 were ⅛″ long, then different size labels L₁, L₂, and L₃ can be formed by the printing system 20 that correspond to labels that are 1.5″, 4.5″ and 6″ long, respectively. The label having size L₁ is produced by cutting the label stock 24 through region 64a, label having size L₂ is produced by cutting the label stock 24 through region 64b, and label having size L₃ is produced by cutting the label stock 24 through region 64c. To produce any of the different size labels, the cutter blade 36 passes through one of the regions 64, selected based on the size of the desired label, and as such does not come into contact with any of the regions of adhesive 54. Accordingly, there will not be any adhesive build up on the cutter blade 36 and the problems associated with such build up are prevented.

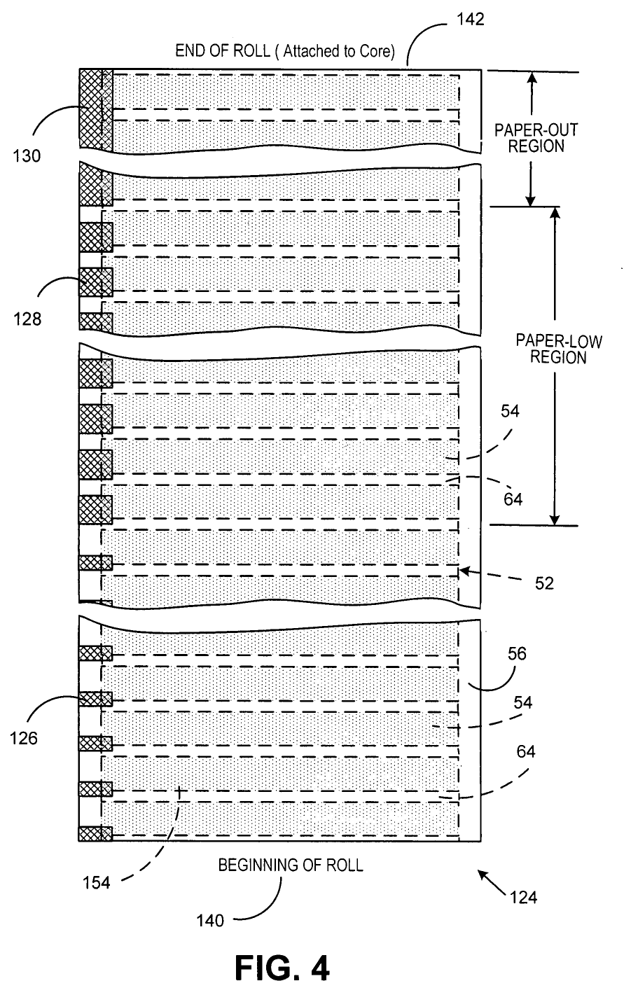

FIG. 4 illustrates an example of an adhesive label stock 124 that includes registration markings that can provide indications of positioning and movement of the label stock 124. Label stock 124 is similar to label stock 24 except that one or more different types of registration markings 126, 128, 130 may be provided. The label stock 124 illustrated in FIG. 4 represents a continuous roll of label stock, having a beginning of the roll portion 140 and an end of roll portion 142 that would be attached to a core. As shown in FIG. 4, there are three different registration markings 126, 128, 130 that may be provided. The registration markings 126, 128, 130 are sensed by sensors, e.g., sensor 32, to provide an indication of positioning of the label stock 124 (for printing and cutting), and the amount of label stock 124 that is remaining on the roll. Preferably, the registration marks 126, 128, 130 are printed on the release liner 56 on the opposite side from where the release liner 56 contacts the adhesive 54.

The registration marks 126 are provided on a first part of the roll of label stock 124 to indicate the locations of the regions 64 and regions of adhesive 54. Using the previous example of the regions of adhesive 54 being ⅜″ long and the regions 64 being ⅛″ long, the registration marks could be formed of, for example, printed marks that are approximately 5/32″ long by 5/16″ wide. The registration marks 126 preferably begin some predetermined distance, such as, for example, 1/16″, from the beginning edge 154 of each regions of adhesive 54. It should be understood that the actual dimensions are not important as long as the relationship between the registration marks 126 and beginning edge 154 of each region of adhesive 54 is known and repeatable. Thus, by sensing one of the registration marks 126 on the label stock using a sensor, e.g. sensor 32, and knowing the fixed distance between the sensor 32 and a downstream device, e.g., cutter 34, the position of the label stock 124 in the cutter 34 can be accurately determined, and therefore the control unit 40, using the transport 28, can accurately position the label stock 124 such that a region 64 is aligned with the cutter blade 36.

In many printing applications it is desirous to know when the end of the roll of label stock 124 is approaching to ensure that there will be sufficient label stock 124 to complete a label that has started to print. Thus, the label stock 124 is also preferably provided with registration marks 128 that are provided on a second part (designated “Paper Low Region” in FIG. 4) of the roll of label stock 124 that is close to the end of the roll 142 of the label stock. The registration marks 128 are different than the registration marks 126 and provide an indication that the end of the roll of label stock 124 is approaching. For example, the registration marks 128 may be twice as long as the registration marks 126, e.g., 5/16″ long by 5/16″ wide. The roll of label stock 124 also preferably includes a registration mark 130 that is provided on a third part (designated “Paper-Out Region” in FIG. 4). Registration mark 130 comprises a continuous black mark that is provided a short distance from the end of the roll of label stock 124 to provide an indication that the label stock 124 is ending. Preferably, the registration mark 130 will be long enough to allow the printing of one last label (of the largest size label) when the registration mark 130 is detected. It should be noted that while the label stock 124 is illustrated in FIG. 4 as being provided with all three different registration marks 126, 128, 130, not all three need to be provided and the label stock may only be provided with one or any combination of two.

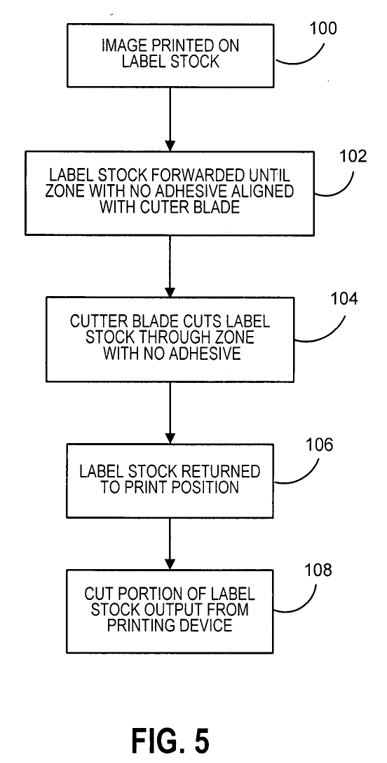

FIG. 5 illustrates in flow chart form an example of the operation of the printing system of FIG. 1 using adhesive label stock 24 or 124. In step 100, a portion of the continuous label stock 24, 124 is printed by the print head 30 of printer 26. When the printing has been completed, in step 102 the label stock 24, 124 is forwarded from the printer 26 to the cutter 34, using the transport 28, until the printed portion of the label stock 24, 124 is downstream of the cutting blade 36 and a region 64 of the label stock 24, 124 is aligned with the cutter blade 36 of the cutter 34. Preferably, to reduce the amount of unused label stock 24, 124, the region 64 that is aligned with the cutter blade 36 is the region 64 that is closest to the end of the printing on the label stock 24, 124. The forwarding of the label stock 24, 124 is controlled by the control unit 40, having knowledge of, for example, the length of the label that was printed, the amount of movement (based on the movement of, for example, a stepper motor that controls the transport 28), and the location of the leading edge of the label stock 24, 124. Where label stock 124 is used, the control unit 40 also utilizes the sensing of the registration marks 126 by the sensor 30 to aid in properly aligning a region 64 having no adhesive with the cutter blade 36. In step 104, the cutter blade 36 is used to cut the label stock 24, 124 in the region 64 where there is no adhesive 54. Because the continuous label stock 24, 124 is cut based on the length of the printed image thereon, labels of various lengths can be generated. Since the cutter blade 36 will always cut through the label stock 24, 124 in a region 64 where there is no adhesive 54, the problems associated with conventional printing systems due to build up of adhesive on the cutter blade are eliminated. In step 106, the new leading edge of the label stock 24, 124 is retracted, by reversing the direction of transport 28, back into the printer 26 to a ready position for printing the next label. In step 108, which may occur simultaneously with, before, or after step 106, the cut portion of the label stock 24, 124 having the image printed thereon is output from the printing system 20. The release liner 56 can then be removed from the cut portion and the label liner 52, having the image printed thereon, can be attached to an article by the adhesive 54.

Thus, by utilizing the continuous label stock 24, 124 in conjunction with the printing system 20, it is possible to print variable length adhesive labels from a continuous supply of label stock without causing any adhesive build up on the cutter used to cut the label stock. Accordingly, any problems previously associated with the build up of adhesive on the cutter blade are eliminated.

While preferred embodiments of the invention have been described and illustrated above, it should be understood that these are exemplary of the invention and are not to be considered as limiting. Those skilled in the art will recognize that various additions, deletions, substitutions, and other modifications can be made without departing from the spirit or scope of the present invention. Accordingly, the invention is not to be considered as limited by the foregoing description of the preferred embodiments but is defined by the appended claims and their equivalents.

What is claimed is:

1. A method for printing variable length adhesive labels from a supply of continuous adhesive label stock in a printing system having a print device and a cutter for cutting adhesive labels from the supply of continuous adhesive label stock, the supply of continuous adhesive label stock including a label liner having a first side suitable for having images printed thereon and a second side including a plurality of first regions where adhesive is provided, the plurality of first regions where adhesive is provided being interspersed with a plurality of second regions where no adhesive is provided, the method comprising:
printing an image on the first side of a portion of the label liner using the print device;
moving the portion of the label liner into the cutter such that the portion of the label liner is downstream of a cutting blade of the cutter;
aligning the cutting blade with one of the plurality of second regions where no adhesive is provided on the second side of the label liner;
separating the portion of the label liner from the supply of continuous adhesive label stock by cutting through the label liner in the second region aligned with the cutting blade.

2. The method according to claim 1, wherein aligning the cutting blade further comprises:
aligning the cutting blade with a second region that is closest to an end of the image on the first side of the portion of the label liner.

3. The method according to claim 1, wherein the continuous adhesive label stock includes a plurality of registration marks that indicate locations of the first and second regions, and aligning the cutting blade further comprises:
using the registration marks to align the cutting blade with one of the plurality of second regions where no adhesive is provided on the second side of the label liner.

4. A continuous adhesive label stock for printing variable length adhesive labels comprising:
a label liner suitable for having images printed thereon on a first side;
a plurality of first regions on a second side of the label liner opposite the first side, the plurality of first regions having an adhesive provided therein; and
a plurality of second regions interspersed with the plurality of first regions, the plurality of second regions having no adhesive provided therein, each of the plurality of second regions extending across a full width of the label liner such that the label liner can be cut into variable length adhesive labels without having to contact any of the plurality of first regions.

5. The continuous adhesive label stock of claim 4, wherein the plurality of first regions and second regions alternate in a repeating pattern.

6. The continuous adhesive label stock of claim 4, wherein each of the plurality of first and second regions have a rectangular shape.

7. The continuous adhesive label stock of claim 4, wherein the plurality of first regions have a first size and the plurality of second regions have a second size different from the first size.

8. The continuous adhesive label stock of claim 7, wherein the plurality of first regions are larger than the plurality of second regions.
